(19) United States
(12) Patent Application Publication
(10) Pub. No.: US 2007/0115916 A1
(43) Pub. Date: May 24, 2007

(54) Method and system for optimizing a network based on a performance knowledge base

(75) Inventors: Nhut Nguyen, Richardson, TX (US); Matt Wu, Plano, TX (US)

Correspondence Address: DOCKET CLERK, P.O. DRAWER 800889, DALLAS, TX, 75380, US

(73) Assignee: SAMSUNG ELECTRONICS Co., LTD., Suwon-city (KR)

(21) Appl. No.: 11/268,217

(22) Filed: Nov. 7, 2005

(51) Int. Cl. H04L 12/28

(52) U.S. Cl. 370/351

(57) ABSTRACT

A method for optimizing a network based on a performance knowledge base is provided. The network comprises a plurality of network elements. The method includes analyzing raw performance data for each of the network elements in real-time to generate processed data based on network policies and optimization rules stored in the performance knowledge base and optimizing the network based on the processed data.

### TECHNICAL FIELD OF THE INVENTION

The present disclosure relates generally to distributed networks and, more specifically, to a method and system for optimizing a network based on a performance knowledge base.

### BACKGROUND OF THE INVENTION

As modern telecommunications networks have become more and more distributed, many network entities in the network are inter-related with each other and work together to provide telecommunication services to network users. At the same time, the traffic load generated by network users is becoming more complicated as more innovative and demanding services are added to network service portfolios. In addition, user mobility has increased with the advances in wireless technologies. These factors lead to telecom networks that require advanced optimization methods. Therefore, there is a need in the art for improved optimization methods to achieve optimized network operations.

### SUMMARY OF THE INVENTION

A method for optimizing a network based on a performance knowledge base is provided. The network comprises a plurality of network elements. According to an advantageous embodiment of the present disclosure, the method includes analyzing raw performance data for each of the network elements in real-time to generate processed data and optimizing the network based on the processed data.

According to one embodiment of the present disclosure, the method also includes generating optimization policies based on the processed data in real-time and optimizing the network based on the processed data comprises provisioning the network elements based on the optimization policies.

According to another embodiment of the present disclosure, the method also includes collecting the raw performance data from each of the network elements in real-time and storing the raw performance data in a performance knowledge base.

According to still another embodiment of the present disclosure, the method also includes receiving optimization rules and network policies from an operator and storing the optimization rules and network policies in the performance knowledge base.

According to yet another embodiment of the present disclosure, the method also includes storing the processed data in the performance knowledge base.

According to a further embodiment of the present disclosure, the method also includes generating optimization policies based on the processed data and on the optimization rules and network policies in real-time and storing the optimization polices in the performance knowledge base.

According to still a further embodiment of the present disclosure, the method also includes generating engineering data based on the processed data and on the optimization policies and storing the engineering data in the performance knowledge base, and optimizing the network based on the processed data comprises provisioning the network elements based on the engineering data.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the term “each” means every one of at least a subset of the identified items; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary distributed network that is capable of being optimized based on a performance knowledge base according to an embodiment of the present disclosure;

FIG. 2 illustrates details of the performance knowledge base of FIG. 1 according to an embodiment of the present disclosure; and

FIG. 3 is a flow diagram illustrating a method for optimizing the network of FIG. 1 based on the performance knowledge base of FIG. 2 according to an embodiment of the present disclosure.

### DETAILED DESCRIPTION OF THE INVENTION

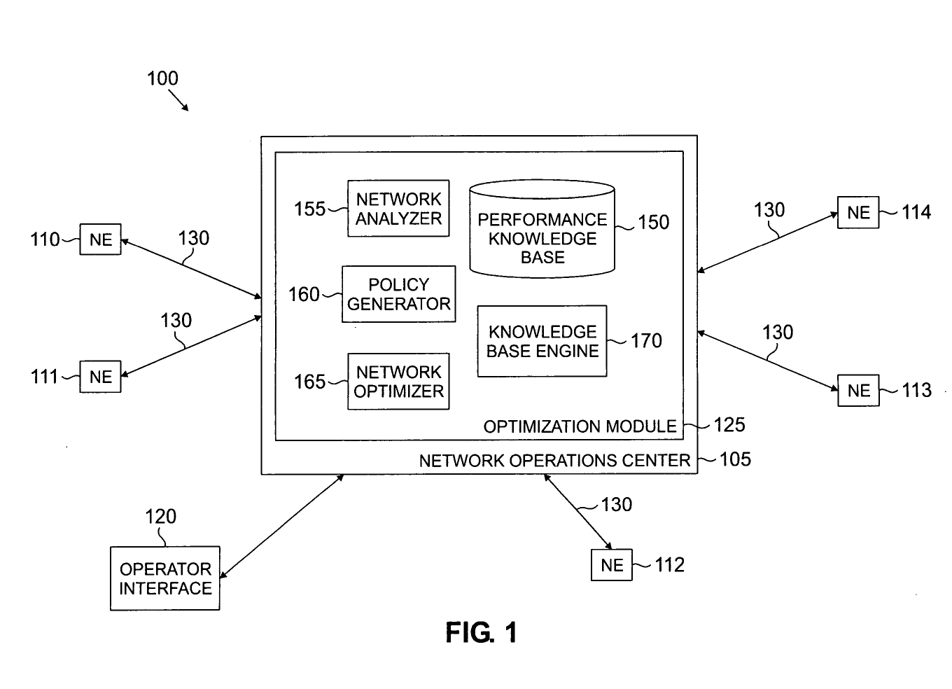

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged distributed network.

To improve operating efficiency of and reduce costs of modern telecommunications networks, service providers are constantly searching for better and more efficient network optimization techniques that are able to handle the more complicated traffic generated by the new services and new mobility capabilities. On the other hand, as new services are added and new technologies are applied, network optimization may require new rules or policies to remain effective.

Conventional optimization techniques collect traffic logs and events of a network node, such as a Mobile Switching Center, for example, and then manually analyze the data to predict future behavior of network users. Results from the traffic analysis are then applied to provisioning and planning for future networks. These techniques typically attempt to optimize each network node separately. However, as networks have become more distributed, the behavior of one network node tends to have more of an effect on, and be more affected by, the behavior of other network nodes.

Therefore, there is a need in the art for an improved method of optimizing a network. In particular, there is a need for a method of optimizing a distributed network more efficiently in a manner capable of handling increasing traffic loads and more demanding services and that takes into account the behavior of multiple network nodes in optimizing each network node in the network.

FIG. 1 illustrates an exemplary distributed network 100 that is capable of being optimized based on a performance knowledge base according to an embodiment of the present disclosure. Distributed network 100 may comprise a telecommunications network or other suitable type of network that comprises distributed components that are operable to function together to provide services for clients.

For one embodiment, network 100 comprises a network operations center 105 and a plurality of network elements (NEs) 110-114. For the illustrated embodiment, network operations center 105 is coupled to an operator interface 120 and comprises an optimization module 125. However, it will be understood that optimization module 125 may be implemented in any suitable component of network 100 or may be implemented independently of any other component without departing from the scope of the present disclosure.

Network operations center 105 may comprise a computer or any other suitable device capable of monitoring and controlling a number of geographically dispersed network elements 110-114. According to one embodiment, network elements 110-114 may comprise base transceiver stations, controllers, routers, switches, service creation points, protocol converters, interface cards, channel cards, transcoders, radios and/or any other suitable network elements. Network operations center 105, and therefore optimization module 125, and network elements 110-114 are operable to communicate with each other over communication links 130, which may comprise T1 lines, Internet Protocol (IP) links through the Internet and/or any other suitable type of communication links.

Operator interface 120 is operable to provide an interface between optimization module 125 and an operator of optimization module 125. Thus, using operator interface 120, an operator may interact with optimization module 125 and prompt optimization module 125 to perform optimization functions. The operator may also provide to optimization module 125 rules and policies that may be used in optimizing network 100. In addition, optimization module 125 is operable to provide optimization information to the operator using operator interface 120. It will be understood that operator interface 120 may also be operable to provide an interface between network operations center 105 and an operator of network operations center 105.

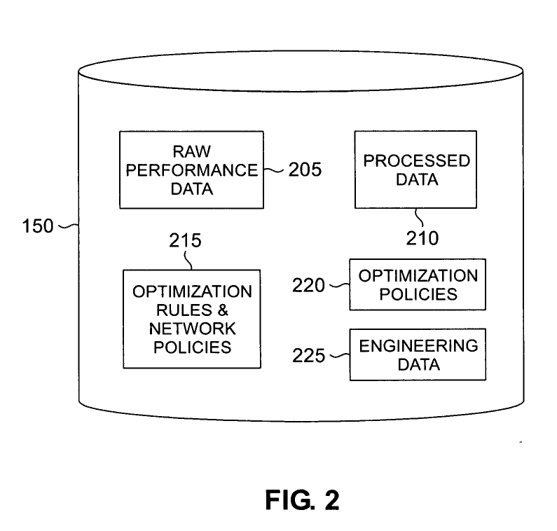

For the illustrated embodiment, optimization module 125 comprises a performance knowledge base 150, a network analyzer 155, a policy generator 160, a network optimizer 165, and a knowledge base engine 170. As described in more detail below in connection with FIG. 2, performance knowledge base 150 comprises any suitable data store, such as a database, that is operable to store optimization data for use in optimizing network 100 and optimization rules and policies for optimizing network 100.

Although illustrated and described as four separate components, it will be understood that any combination of two or more of network analyzer 155, policy generator 160, network optimizer 165 and knowledge base engine 170 may be implemented together as a single component without departing from the scope of the present disclosure.

Network analyzer 155 is operable to analyze raw performance data stored in performance knowledge base 150 to generate processed data and may be operable to store the processed data in performance knowledge base 150. Policy generator 160 is operable to generate optimization policies for network 100 based on optimization rules and network policies stored in performance knowledge base 150 and may be operable to store the optimization policies in performance knowledge base 150.

Network optimizer 165 is operable to generate network engineering data for provisioning network 100 based on the network optimization policies generated by policy generator 160 and based on the processed data analyzed by network analyzer 155. Network optimizer 165 may also be operable to store the engineering data in performance knowledge base 150.

Knowledge base engine 170 is operable to manage data, rules and policies stored in performance knowledge base 150. Knowledge base engine 170 is also operable to derive new rules and policies according to changes in the stored data. For one embodiment, knowledge base engine 170, instead of network analyzer 155, policy generator 160 and network optimizer 165, may be operable to store the processed data, optimization policies and engineering data in performance knowledge base 150.

FIG. 2 illustrates details of performance knowledge base 150 according to an embodiment of the present disclosure. For the illustrated embodiment, performance knowledge base 150 comprises raw performance data 205, processed data 210, optimization rules and network policies 215, optimization policies 220, and engineering data 225. It will be understood that performance knowledge base 150 may store additional types of data without departing from the scope of the present disclosure.

In addition, although each of raw performance data 205, processed data 210, optimization rules and network policies 215, optimization policies 220, and engineering data 225 may be stored separately in segmented portions of performance knowledge base 150, it will be understood that any or all of these sections of data 205, 210, 215, 220 and 225 may be stored together in performance knowledge base 150 and identified as distinct types of data 205, 210, 215, 220 and/or 225 in any suitable manner without departing from the scope of the present disclosure.

Raw performance data 205 comprises information pertinent to network operation and performance that is collected by knowledge base engine 170 in real-time from network elements 110-114. Thus, network performance data, such as the number of calls processed, processing costs in terms of CPU cycles for a particular call and/or other suitable performance data, is collected from network elements 110-114 and stored in raw performance data 205 as network 100 is operating. Based on the manner in which the phrase is used, it will be understood that “raw performance data 205” may refer to the actual raw performance data stored in performance knowledge base 150 or to the portion of performance knowledge base 150 in which the raw performance data is stored.

Processed data 210 comprises information that is used for network operation and optimization tasks. Processed data 210 is generated by network analyzer 155 in real-time based on raw performance data 205. Based on the manner in which the phrase is used, it will be understood that “processed data 210” may refer to the actual processed data stored in performance knowledge base 150 or to the portion of performance knowledge base 150 in which the processed data is stored.

Optimization rules and network policies 215 comprise rules and policies stored in performance knowledge base 150 by an operator using operator interface 120. These rules and policies 215 govern how network optimization policies 220 are produced. Based on the manner in which the phrase is used, it will be understood that “optimization rules and network policies 215” may refer to the actual optimization rules and network policies stored in performance knowledge base 150 or to the portion of performance knowledge base 150 in which the optimization rules and network policies are stored.

Optimization policies 220 comprise policies generated by policy generator 160 based on processed data 210 and optimization rules and network policies 215. Based on the manner in which the phrase is used, it will be understood that “optimization policies 220” may refer to the actual optimization policies stored in performance knowledge base 150 or to the portion of performance knowledge base 150 in which the optimization policies are stored.

Engineering data 225 comprises information used for provisioning network 100 such that network 100 is operated in a manner that achieves the goals set for network optimization. Engineering data 225 is generated by network optimizer 165 based on processed data 210 and optimization policies 220 and is used to provision network elements 110-114. Based on the manner in which the phrase is used, it will be understood that “engineering data 225” may refer to the actual engineering data stored in performance knowledge base 150 or to the portion of performance knowledge base 150 in which the engineering data is stored.

Raw performance data 205 and processed data 210, as well as optimization rules and network policies 215, may be managed by knowledge base engine 170. In addition, knowledge base engine 170 may derive new rules and policies according to changes in raw performance data 205 and processed data 210.

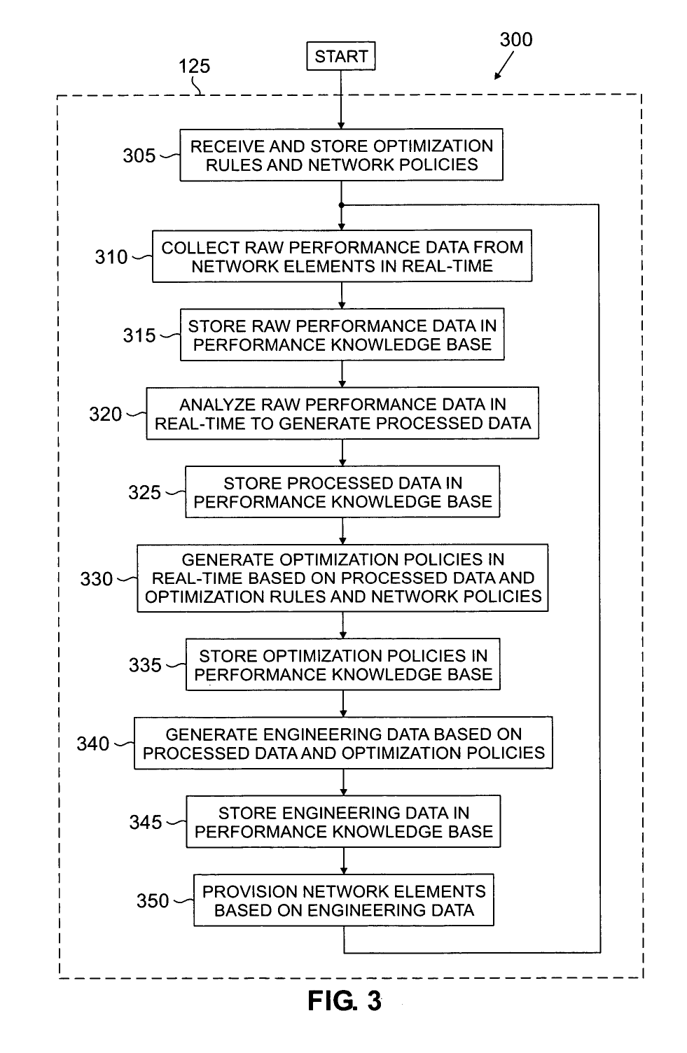

FIG. 3 is a flow diagram illustrating a method 300 for optimizing network 100 based on raw performance data 205 according to an embodiment of the present disclosure. Initially, optimization module 125 receives optimization rules and network policies 215 and knowledge base engine 170 stores those rules and policies 215 in performance knowledge base 150 (process step 305). For one embodiment, optimization module 125 may receive the optimization rules and network policies 215 from an operator through operator interface 120.

Knowledge base engine 170 collects raw performance data 205 from network elements 110-114 in real-time while network 100 is operating (process step 310) and stores the raw performance data 205 in performance knowledge base 150 (process step 315). Network analyzer 155 then analyzes the raw performance data 205 stored in performance knowledge base 150 in real-time to generate processed data 210 (process step 320). Knowledge base engine 170 may then store the processed data 210 in performance knowledge base 150 (process step 325). Alternatively, network analyzer 155 may store the processed data 210 in performance knowledge base 150.

Policy generator 160 then generates optimization policies 220 in real-time based on the processed data 210 and the optimization rules and network policies 215 stored in performance knowledge base 150 (process step 330). Knowledge base engine 170 may then store the optimization policies 220 in performance knowledge base 150 (process step 335). Alternatively, policy generator 160 may store the optimization policies 220 in performance knowledge base 150.

Network optimizer 165 then generates engineering data 225 based on the processed data 210 and optimization policies 220 stored in performance knowledge base 150 (process step 340). Knowledge base engine 170 may then store the engineering data 225 in performance knowledge base 150 (process step 345). Alternatively, network optimizer 165 may store the engineering data 225 in performance knowledge base 150.

Finally, optimization module 125 provisions network elements 110-114 based on the engineering data 225 stored in performance knowledge base 150 (process step 350). While the method is being performed and/or after provisioning network 100, knowledge base engine 170 may continue to collect additional raw performance data 205 in real-time from network elements 110-114 (process step 310). It will be understood that optimization module 125 may receive changes to and/or additional optimization rules and network policies 215 (process step 305) from an operator through operator interface 120 at any suitable time.

In this way, as new services and traffic conditions are applied to network 100, new traffic characteristics are extracted by optimization module 125 in real-time. These characteristics are then used by policy generator 160, also in a real-time manner, to generate new optimization policies 220 that adapt to the new traffic conditions. These optimization policies 220 may then be used to generate engineering data 225 for provisioning network 100 in such a way as to ensure that the optimization goals are consistently achieved. Thus, network 100 may be optimized based on data provided by each network element 110-114, thereby taking into account any effects from surrounding network elements 110-114 on each other network element 110-114, and based on a real-time analysis of the data.

While several embodiments have been provided in the present disclosure, it should be understood that the disclosed systems and methods may be embodied in many other specific forms without departing from the spirit or scope of the present disclosure. The exemplary embodiments disclosed are to be considered as illustrative and not restrictive, and the intention is not to be limited to the details given herein. It is intended that the disclosure encompass all alternate forms within the scope of the appended claims along with their full scope of equivalents.

What is claimed is:

1. A method for optimizing a network based on a performance knowledge base, the network comprising a plurality of network elements, comprising:
analyzing raw performance data for each of the network elements in real-time to generate processed data; and
optimizing the network based on the processed data.

2. The method as set forth in claim 1, further comprising:
generating optimization policies based on the processed data in real-time; and
optimizing the network based on the processed data comprising provisioning the network elements based on the optimization policies.

3. The method as set forth in claim 1, further comprising:
collecting the raw performance data from each of the network elements in real-time; and
storing the raw performance data in the performance knowledge base.

4. The method as set forth in claim 3, further comprising:
receiving optimization rules and network policies from an operator; and
storing the optimization rules and network policies in the performance knowledge base.

5. The method as set forth in claim 4, further comprising storing the processed data in the performance knowledge base.

6. The method as set forth in claim 5, further comprising:
generating optimization policies based on the processed data and on the optimization rules and network policies in real-time; and
storing the optimization polices in the performance knowledge base.

7. The method as set forth in claim 6, further comprising:
generating engineering data based on the processed data and on the optimization policies;
storing the engineering data in the performance knowledge base; and
optimizing the network based on the processed data comprising provisioning the network elements based on the engineering data.

8. A method for optimizing a network based on a performance knowledge base, the network comprising a plurality of network elements, comprising:
collecting raw performance data from each of the network elements; and
optimizing each network element based on the raw performance data received from each of the network elements.

9. The method as set forth in claim 8, further comprising analyzing the raw performance data to generate processed data.

10. The method as set forth in claim 9, further comprising:
receiving optimization rules and network policies from an operator; and
generating optimization policies based on the processed data and on the optimization rules and network policies.

11. The method as set forth in claim 10, further comprising generating engineering data based on the processed data and on the optimization policies.

12. The method as set forth in claim 11, optimizing each network element based on the raw performance data received from each of the network elements comprising provisioning the network elements based on the engineering data.

13. The method as set forth in claim 10, collecting the raw performance data from each of the network elements comprising collecting the raw performance data from each of the network elements in real-time, analyzing the raw performance data comprising analyzing the raw performance data in real-time, and generating optimization policies comprising generating optimization policies in real-time.

14. An optimization module for optimizing a network based on a performance knowledge base, the network comprising a plurality of network elements, comprising:
a network analyzer operable to analyze raw performance data for each of the network elements in real-time to generate processed data;
a policy generator operable to generate optimization policies based on the processed data in real-time; and
a network optimizer operable to generate engineering data based on the processed data and on the optimization policies, the optimization module operable to optimize the network based on the engineering data.

15. The optimization module as set forth in claim 14, further comprising the performance knowledge base operable to store the raw performance data, the processed data, the optimization policies, and the engineering data.

16. The optimization module as set forth in claim 15, further comprising a knowledge base engine operable to manage the performance knowledge base.

17. The optimization module as set forth in claim 16, the knowledge base engine further operable to collect the raw performance data from each of the network elements in real-time and to store the raw performance data in the performance knowledge base.

18. The optimization module as set forth in claim 16, the optimization module further operable to receive optimization rules and network policies from an operator, and the knowledge base engine further operable to store the optimization rules and network policies in the performance knowledge base.

19. The optimization module as set forth in claim 18, the policy generator further operable to generate the optimization policies based on the optimization rules and network policies.

20. The optimization module as set forth in claim 14, the optimization module operable to optimize the network based on the engineering data by provisioning the network elements based on the engineering data.
